(19) United States
(12) Patent Application Publication
(10) Pub. No.: US 2012/0096937 A1
(43) Pub. Date: Apr. 26, 2012

(54) Flow measuring device and method for manufacture of a measuring tube of a flow measuring device

(75) Inventors: Thomas Sulzer, Grenzach-Wyhlen (DE); Alexander Stünzi, Ettingen (CH); Frank Voigt, Weil am Rhein (DE); Werner Wohlgemuth, Seewan (CH)

(73) Assignee: Endress + Hauser Flowtec AG, Reinach (CH)

(21) Appl. No.: 12/654,460

(22) Filed: Dec. 22, 2009

(30) Foreign Application Priority Data
Dec. 19, 2008 (DE) 10 2008 054961.4

(51) Int. Cl. G01F 15/00; B29C 69/00; B29C 65/56

(52) U.S. Cl. 73/272 R; 264/249

(57) ABSTRACT

A method for the manufacture of a measuring tube of a flow measuring device, and to a flow measuring device. The measuring tube has a lumen for accommodating a flowing, measured material. The method comprises: introducing at least one, essentially cylindrical, hollow body into a support tube; joining the essentially cylindrical, hollow body to the support tube by mechanically deforming at least one portion of the essentially cylindrical, hollow body; and embedding the hollow body joined to the support tube in an electrically and/or chemically insulating, isolating material; wherein the lumen of the measuring tube is formed by the electrically and/or chemically insulating, isolating material.

### TECHNICAL FIELD

The invention relates to a method for the manufacture of a measuring tube of a flow measuring device, wherein the measuring tube has a lumen for accommodating a flowing, measured material. Furthermore, the invention relates to a flow measuring device having a measuring tube comprising a support tube, wherein the measuring tube is lined with an electrically insulating, isolating material.

### BACKGROUND DISCUSSION

For determining quantity of flow, plants of process, and/or automation, technology apply measuring methods such as magneto-inductive flow measurement or ultrasound flow measurement. Due to the measuring method and/or due to hygienic requirements, electrical insulation and/or chemical isolation of the measured material from its environment are/is necessary. Flow measuring devices resting on such measuring principles are connected to pipelines and include a measuring tube. Pipelines or measuring tubes are composed of a, most often, metal, support tube, an insulating, isolating lining, and a reinforcement provided in the insulating lining in the form of a support body. Usually, the support body is introduced into the support tube and is in contact with it.

There are measuring tubes, especially known from magneto-inductive flow measurement, which are provided with a lining, the so-called liner, on the inside, in order to insulate electrically and/or isolate chemically the electrodes from the support tube. An adhered or vulcanized or pressed-in liner has the disadvantage, that the adhesion between support tube and liner in the case of temperature, or pressure, fluctuations is not sufficiently assured. This can lead to release, for example, due to different coefficients of thermal expansion between support tube and liner or due to occurring, negative pressure. Sprayed on, or thermally melted on, liners have, most often, lesser insulating, isolating properties, whereby accuracy of measurement and life of the measuring tubes are lessened.

Known from the state of the art are securement designs, in the case of which the liner is secured on the inside of the support tube with dovetail, or bridge, designs. Such pointwise securement cannot durably avoid release of the liner. Furthermore, support bodies are known, which are introduced into the support tube, in order to reinforce the liner. Such support bodies include a tube with a smaller outer diameter than the inner diameter of the support tube and a certain number of holes. The support body is introduced into the support tube and becomes completely surrounded by the insulating, isolating material. The number of holes is to be carefully chosen, since, in the case of large hole separation, there is danger of a release of the insulating, isolating material from the tube serving for reinforcement. The amount of the insulating, isolating material, which must coat the tube serving for reinforcement completely, is relatively high.

A further support body known from the state of the art is composed of a lattice- or net-like, especially three dimensional, weave, which can be produced from different materials, for example, from metal, which is introduced into the support tube and connected with it by pointwise bonding and which is surrounded by the electrically and/or chemically insulating, isolating material. In order to assure a sufficient stability of the liner, many securement points are necessary. Reinforcement with such a support body is very complicated to implement in the case of conical configuration of the inner diameter of the measuring tube.

EP 0581017 B1 describes a measuring tube having a porous support body, which is in contact with the support tube and in the case of which the material of the insulating, isolating lining does not reach the inside of the support tube. In this way, pores on the side of the support body facing the support tube are unfilled.

All the known designs have the disadvantage that they are relatively complicated to manufacture and therewith are relatively expensive.

### SUMMARY OF THE INVENTION

An object of the invention is, consequently, to provide for industrial applications a cost effectively manufacturable, flow measuring device and a method for the manufacture of a measuring tube with an electrically and/or chemically insulating, isolating lining, wherein the method involves few method steps and, thus, can be implemented cost effectively.

The object is achieved according to the invention by a flow measuring device and a method for manufacture of a measuring tube of a flow measuring device.

As regards the method, the object is achieved by a method comprising steps as follows: introducing at least one, essentially cylindrical, hollow body into a support tube; joining the essentially cylindrical, hollow body to the support tube by mechanically deforming at least one portion of the essentially cylindrical, hollow body; and embedding the hollow body joined to the support tube in an electrically and/or chemically insulating, isolating material; wherein the lumen of the measuring tube is formed by the electrically and/or chemically insulating, isolating material. By the mechanical deformation, the hollow body can be, especially radially, widened and stretched and thereby matched to the support tube. Moreover, by the mechanical deformation, the diameter of the essentially cylindrical, hollow body can be enlarged, at least in the section, in which the essentially cylindrical, hollow body is deformed. There is obtained an only difficultly releasable, cylindrical, press connection between hollow body and support tube, by whose static friction the hollow body is affixed to the support tube. The essentially cylindrical, hollow body can have, for this, a shape matched to the shape of the support tube. For such purpose, an essentially cylindrical, hollow body, whose outer diameter is smaller than the inner diameter of the support tube, can be used and introduced into the support tube. The hollow body joined by the mechanical deformation to the support tube can serve as support body for the lining composed of an electrically and/or chemically insulating, isolating material. For such purpose, the hollow body joined to the support tube can be embedded in the electrically and/or chemically insulating, isolating material and can serve as anchoring, or securement, for the electrically and/or chemically insulating, isolating material. The lumen of the measuring tube is, for example, completely surrounded, or formed, by the electrically and/or chemically insulating, isolating material. Of advantage, in such case, is the more favorable manufacture of the measuring tube and of flow measuring devices having a measuring tube, due to saved material, and manufacturing, costs compared, for example, to the sinter method. Furthermore, the proposed method simplifies the manufacture of a flow measuring device, because, due to the fact that only mechanical deformation is used, a faster and more precise manufacture of measuring tubes is achieved.

In an embodiment, the essentially cylindrical, hollow body is deformed by a rolling method. By rolling, the essentially cylindrical, hollow body introduced into the support tube can, with targeting, be deformed, or widened, i.e. be enlarged in diameter. In such case, the essentially cylindrical, hollow body can be deformed by rotating tools, this being referred to as rolling. The rolling method can additionally advantageously be performed in an automated manner. By the rolling, the essentially cylindrical, hollow body can be stretched, or widened. Alternatively, the essentially cylindrical, hollow body can be widened and joined to the support tube by a mandrel or another expansion tool.

In an additional embodiment, the support tube has an inner surface, wherein the essentially cylindrical, hollow body is joined to the inner surface of the support tube by mechanical deformation of at least one portion of the essentially cylindrical, hollow body. For example, by means of the rolling method, a press connection can be produced between the essentially cylindrical, hollow body and the support tube on the inner surface of the support tube, in that the essentially cylindrical, hollow body is rolled onto the wall of the support tube. In this way, the essentially cylindrical, hollow body can be joined to the support tube radially along the entire circumference and along a portion of the longitudinal axis of the measuring tube. It is, however, for example, sufficient mechanically to deform, or to roll, the essentially cylindrical, hollow body only in a section along the longitudinal axis of the measuring tube, in order to obtain a press connection sufficient for affixing the essentially cylindrical, hollow body to the support tube.

In a further development, at least one perforated tube is used as the essentially cylindrical, hollow body. A perforated sheet is a metal grate formed by punching portions out of a sheet. The perforated sheet can be formed into a perforated tube. The perforated tube can have various perforations, i.e. hole shapes and arrangements of the holes relative to one another, such as, for example, round or square holes, which are arranged in rows relative to one another, lined up or offset. The holes serve as anchoring for the electrically and/or chemically insulating, isolating material, of which the lining is composed. The electrically and/or chemically insulating, isolating material penetrates into the holes and is, so, secured, respectively, to the joined hollow body and to the support tube. The electrically and/or chemically insulating, isolating material is applied after the joining of the essentially cylindrical, hollow body to the support tube and embedded in the hollow body joined to the support tube. The hollow body joined to the support tube is preferably completely surrounded by the electrically and/or chemically insulating, isolating material.

In an additional development, the difference between the inner diameter of the support tube and the outer diameter of the essentially cylindrical, hollow body amounts to less than 1 mm. Both the support tube as well as also the essentially cylindrical, hollow body can, due to their given thicknesses, have at least one inner and one outer diameter. By the mechanical deformation, the outer diameter of the essentially cylindrical, hollow body can be fittted to the inner diameter of the support tube. In such case, the essentially cylindrical, hollow body is, above all, respectively, radially stretched and widened. Due to the material properties, especially of a metal sheet, and the tools needed for the manufacture and forces acting in the manufacture, it has proved as advantageous, to choose the size of the outer diameter of the essentially cylindrical, hollow body, to be, at most, 1 mm smaller than the inner diameter of the support tube.

If the essentially cylindrical, hollow body is joined to the support tube only in a section along the longitudinal axis of the measuring tube, then there arises in the remaining region, in which the essentially cylindrical, hollow body is introduced into the support tube, a gap between the essentially cylindrical, hollow body and the wall of the support tube. This gap can also serve as anchoring for the electrically and/or chemically insulating, isolating'material. The electrically and/or chemically insulating, isolating material can flow through the holes of the perforated support tube into the gap and in the gap between the perforated tube and the support tube back together. This is especially advantageous, since the electrically and/or chemically insulating, isolating material is often a synthetic material, or plastic, which, for example, is cast in a mold and during the cooling tends to shrink. On the basis of this behavior, that the electrically and/or chemically insulating, isolating material flows in the gap, the lining remains, also after the cooling of the material, sufficiently secured to the support tube.

As regards the flow measuring device, the object is achieved by the features, that at least one, essentially cylindrical, hollow body is joined to the support tube by mechanical deformation and that the essentially cylindrical, hollow body is embedded in the electrically and/or chemically insulating, isolating material. Such a measuring tube is essentially more favorable in its manufacture, has smaller manufacturing tolerances and exhibits, nevertheless, a high stability of the lining.

In a form of embodiment of the flow measuring device, the essentially cylindrical, hollow body is composed of sheet formed to have a tubular shape. A tube of sheet material, especially metal sheet, or sheet metal, is easy to work, especially to deform, and is cost effective.

In an additional form of embodiment of the flow measuring device, the essentially cylindrical, hollow body has at least one perforating. The perforating serves for securement of the electrically and/or chemically insulating, isolating material, of which the lining is composed. The electrically and/or chemically insulating, isolating material is, for example, injected or cast into the holes and experiences thereby a hold, which prevents the lining from releasing from the support tube or support body.

In an embodiment of the flow measuring device, the essentially cylindrical, hollow body joined to the support tube is, at least in an end region of the measuring tube serving for connecting the measuring tube to a pipeline, free of perforating. In this way, the lining on the two ends of the measuring tube can have an essentially constant coating thickness, so that a pressure sealed connection to a pipeline can be produced relative to the measured material or the process.

In an additional embodiment of the flow measuring device, the essentially cylindrical, hollow body is joined to the support tube along at least one radially extending region. Due to the high static friction arising from the deforming, the hollow body need not be joined to the support tube along its total longitudinal axis; rather it suffices to deform at least one radially extending region onto the support tube and so to manufacture a press connection. Preferably, the essentially cylindrical, hollow body is deformed and joined to the support tube at least in the region in which it has perforating.

In a variant of the flow measuring device, the essentially cylindrical, hollow body is composed of a first perforated tube with a first perforating and a second perforated tube with a second perforating, wherein the first perforated tube surrounds the second perforated tube. The second perforated tube can be introduced into the first perforated tube and is surrounded by such. In such case, the hole diameter of the second perforating can be so selected that, when the two perforated tubes are pushed into one another, a hole with the first hole diameter at least partially includes at least two holes of the second perforating. For such purpose, the hole diameter of the first perforating can be selected to be at least as large as the spacing of the second perforating. ‘Spacing’, in this context, means the distance between the centers of two neighboring holes. In this way, an electrically and/or chemically insulating, isolating material forming the lining can enter into the holes of the second perforating and within a hole of the first perforating flow back together to two holes of the second perforating. In this way, the electrically and/or chemically insulating, isolating material is anchored in the hollow body functioning as support body. The support body for the lining can thus be composed of only one perforated tube or, however, of two or more perforated tubes pushed one into another.

In an additional variant of the flow measuring device, the first perforating has holes with a first hole diameter and the second perforating has holes with a second hole diameter, wherein the second hole diameter is smaller than the first hole diameter. Especially, the first perforating can have holes with a first hole diameter of at least approximately the land width or at least approximately the spacing of the second perforating. The land width is the length of the imperforated, intermediate space between two neighboring holes.

In a form of embodiment of the flow measuring device, the difference between the inner diameter of the support tube and the outer diameter of the essentially cylindrical, hollow body provided in the support tube is greater than or equal to the elastic limit of the material, of which the essentially cylindrical, hollow body is composed. Within the elastic limit of a material, plastic deformation does not occur. In order to manufacture a stable press connection between the essentially cylindrical, hollow body and the support tube, the difference between the outer diameter of the essentially cylindrical, hollow body and the inner diameter of the support tube must be selected to be, consequently, greater than or equal to the elastic limit of the material, of which the essentially cylindrical, hollow body is composed.

### BRIEF DESCRIPTION OF THE DRAWINGS

The invention will now be explained in greater detail on the basis of the appended drawing, the figures of which show as follows:

FIG. 1a is a side view of a first perforated tube;

FIG. 1b is a cross section through the first perforated tube;

FIG. 2a is a side view of a second perforated tube;

FIG. 2b is a cross section through the second perforated tube;

FIG. 3a is a perspective view of a support body formed of first and second perforated tubes;

FIG. 3b is a cross section through the support body; and

FIG. 4 is a plan view onto a hole of the first perforating in the region in which the first and second perforating of the support body overlap.

### DETAILED DISCUSSION IN CONJUNCTION WITH THE DRAWINGS

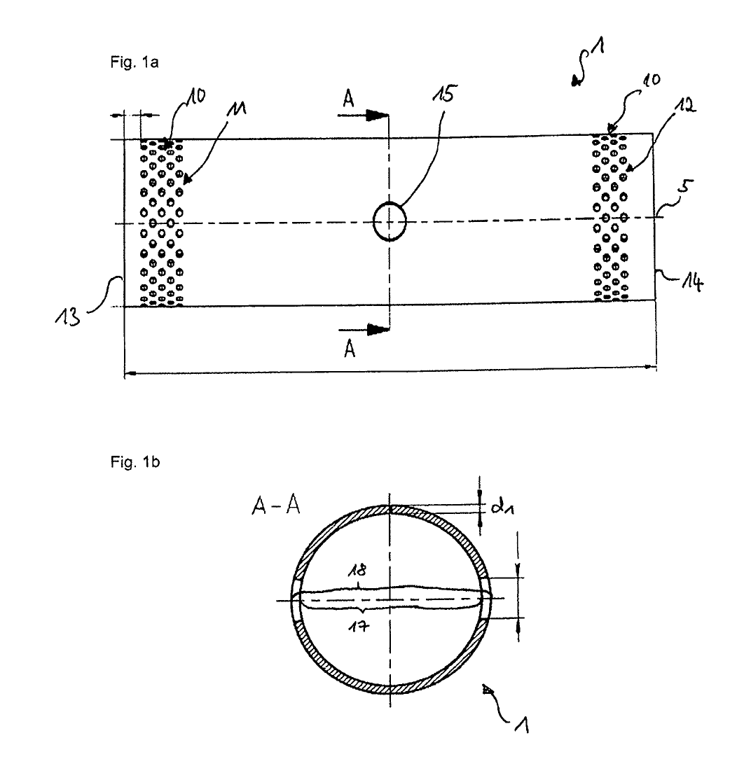

FIG. 1a shows a side view of a first perforated tube 1. The perforated tube can be used as a support body for the lining of a measuring tube of a magneto-inductive flow measuring device or is part of such a support body formed of a plurality of perforated tubes 1. Alternatively, the first perforated tube 1 can also serve as support body for the lining of an ultrasound, flow measuring device. The first perforated tube 1 has a cylindrical shape. Furthermore, the first perforated tube 1 has on its lateral surface in two annular sections 11, a first perforating. The first annular section 11 is located in the region of the bottom 13 and a second annular section 12 is located in the region of the top 14 of the cylindrical, first, perforated tube 1. The first perforated tube 1 includes a first perforating 10 with round holes and an offset between the rows of the holes. The holes have a hole diameter 11.

In the areas of the top 14 and the bottom 13 as well as between the first and the second annular sections 11, 12, the perforated tube 1 is free of the first perforating 10, i.e. imperforated. The perforated tube 1 includes centrally a cutout 15, which serves for accommodating a measuring, or reference, electrode.

The first perforated tube 1 can also be provided along the whole longitudinal axis 5 radially with the first perforating; this, however, is not shown.

FIG. 1b shows a cross section at the height of the cutout 15 for the measuring, or reference, electrode. The first perforated tube 1 has a first thickness d1. Furthermore, the first perforated tube 1 has an outer and an inner diameter 17, 18.

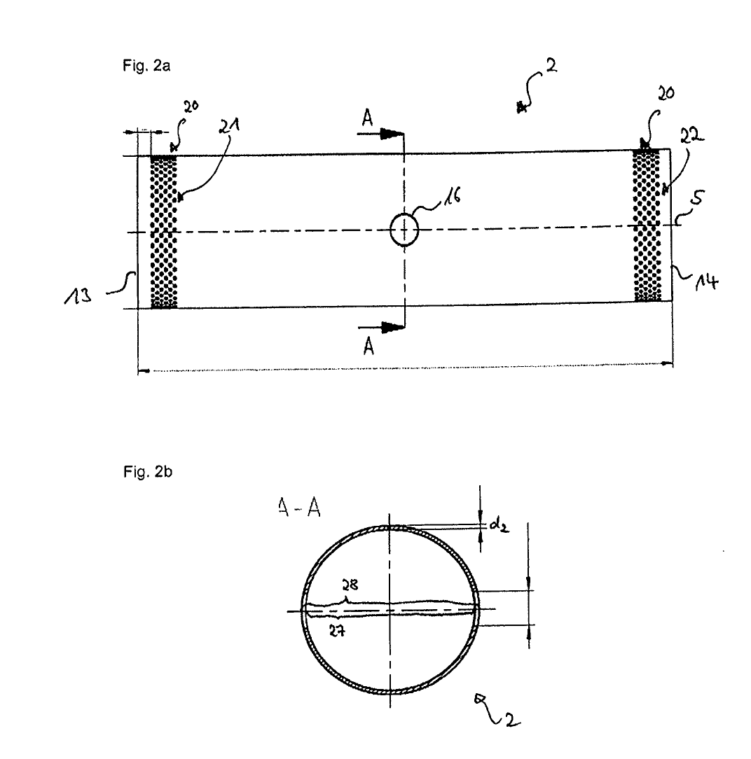

FIG. 2a shows a second perforated tube 2 in a side view. Likewise as the first perforated tube 1, the second perforated tube 2 according to the invention can be used as a support body or part of a support body of a plurality of perforated tubes 3.

The second perforated tube 2 has in two annular sections 21, 22 a second perforating 20 with round holes. The holes have a hole diameter 19. The width of these annular sections 21, 22 is in such case smaller than the width of the first perforating 10 with annular sections 11, 12 of the first perforated tube 1. The rows of the second perforating 20 are likewise offset relative to one another. The second perforated tube 2 has a smaller inner diameter 27 than the first perforated tube 1, so that it can be introduced into the first perforated tube 1.

Furthermore, the second perforated tube 2 has, compared to the first perforated tube 1 a smaller, second thickness d2. Likewise as the first perforated tube 1, the second perforated tube 2 has an inner and an outer diameter 27, 28. Additionally, also on the second perforated tube 2, there is provided a cutout 16 for a measuring, or reference, electrode.

The second perforated tube 2 can also be provided along the whole longitudinal axis 5 radially with the second perforating 20; this, is not shown, however.

FIG. 2b shows a cross section at the height of the cutout 16, which serves for accommodating the measuring, or reference, electrode.

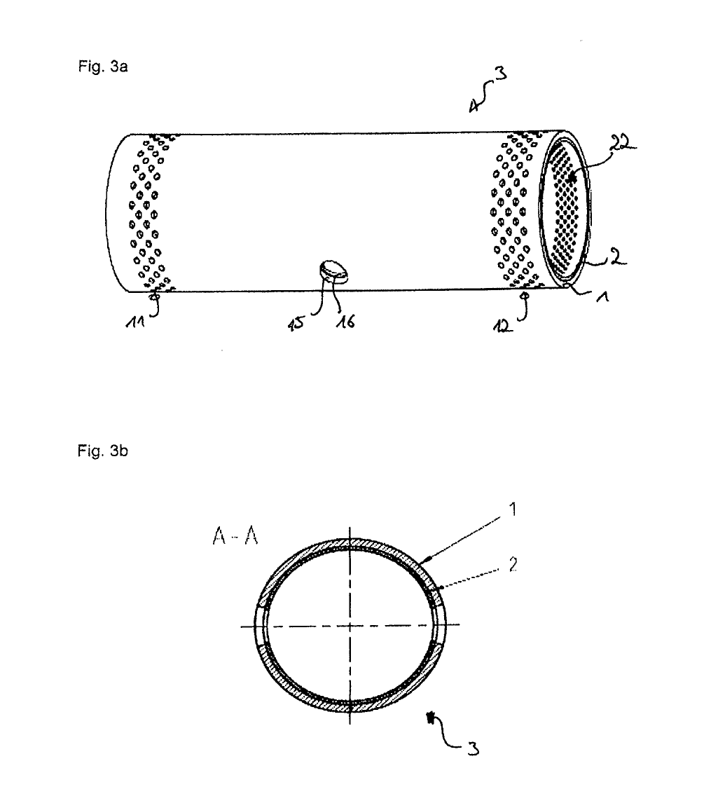

FIG. 3a shows a perspective view of an essentially cylindrical, hollow body preassembled from a first and a second perforated tube 1, 2 and serving as support body 3.

The two perforated tubes 1, 2 are, for this purpose, pushed into one another and affixed with one another. The so preassembled, support body 3 is then inserted into the support tube (not shown), and joined to the support tube by mechanical deformation. By the mechanical deformation, a press connection is produced between support tube and support body 3.

The two perforated tubes 1, 2 are inserted into the support tube and positioned via the there provided, electrode holes. The perforated tube ends 13, 14 are partially rolled, at least in the region in which the second perforated tube 2 has the second perforating 20, and joined to the support tube. By the different perforating 10, 20, the electrically and/or chemically insulating, isolating material can penetrate between the perforated sheets of the tubes 1, 2.

In a variant, a first perforated tube 1 with an approximately 1 mm smaller outer diameter 18 than the inner diameter of the support tube is pushed into the support tube. Then, the perforated tube 1 is rolled and joined to the inner diameter of the support tube. The produced press connection can withstand the injection pressure present, respectively, in the lining of the support tube and in the embedding of the support body 3. In the more central part of the measuring tube, there arises a gap between the perforated tube 1 and the support tube wall, which serves as anchoring for the electrically and/or chemically insulating, isolating material.

The electrically and/or chemically insulating, isolating material can get into the gap between the essentially cylindrical, hollow body serving as support body 3 through the cutout 15, 16 for the measuring, or reference, electrode.

Alternatively, instead of the first perforated tube 1, two rings are used, which are rolled in at the ends of the support tube. In such case, there arises between the second perforated tube 2 and the wall of the support tube a gap, which serves as anchoring for electrically and/or chemically insulating, isolating material.

The electrically and/or chemically insulating, isolating material is composed, for example, of a polytetrafluoroethylene PTFE, a perfluoroalkoxy PFA or a polyamide PA.

By the embedding of the hollow body, or the support body, 3 in the electrically and/or chemically insulating, isolating material, the lumen of the measuring tube for accommodating the measured material is formed.

FIG. 3b shows a cross section through the essentially cylindrical, hollow body serving as support body 3 at the height of the cutout for the measuring, or reference, electrode. Shown in the cross section are the first and second perforated tubes 1, 2 of the support body 3.

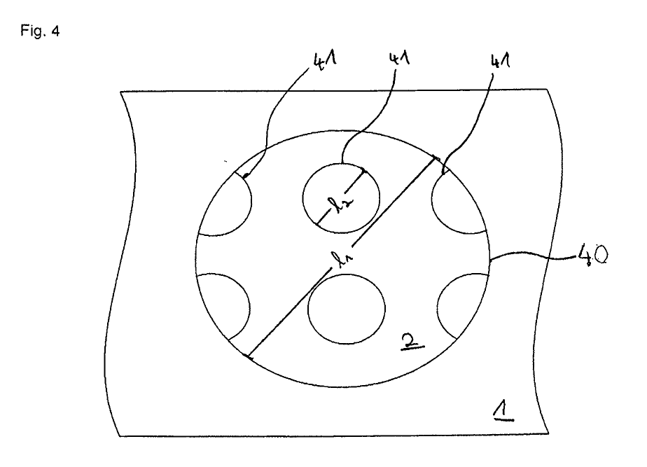

FIG. 4 shows a plan view onto a hole 40 of the first perforated tube 1. The second perforated tube 2 is pushed into the first perforated tube 1 and there affixed. The shown hole 40 is located in the region, in which the first and second perforatings 10, 20 overlap. Visible through the hole 40 is the second perforating 20 of the second perforated tube 2.

If the electrically and/or chemically insulating, isolating material is melted into the support body 3, the electrically and/or chemically insulating, isolating material flows through the holes 41 of the second perforating 20 into the hole 40 of the first perforating 10 and there back together. In this way, the electrically and/or chemically insulating, isolating material, of which the lining is composed, can be secured to the support body 3, in that it anchors there. In the illustrated hole 40 of the first perforating 10, the electrically and/or chemically insulating, isolating material comes together again and so cares for an especially secured anchoring of the lining. The electrically and/or chemically insulating, isolating material, which, for example, is composed of a synthetic material, or plastic, tends during the cooling to shrink, i.e. to undergo a volume reduction. By the flowing behind of the electrically and/or chemically insulating, isolating material into the hole 40 of the first perforating 10 and into the holes 41 of the second perforating 20, an especially durable connection is achieved.

1-13. (canceled)

14. A method for the manufacture of a measuring tube of a flow measuring device, wherein the measuring tube has a lumen for accommodating a flowing, measured material, which method comprises the steps of:
introducing at least one essentially cylindrical, hollow body into a support tube;
joining the essentially cylindrical, hollow body to the support tube by mechanically deforming at least one portion of the essentially cylindrical, hollow body; and
embedding the hollow body joined to the support tube in an electrically and/or chemically insulating, isolating material, wherein:
the lumen of the measuring tube is formed by the electrically and/or chemically insulating, isolating material.

15. The method as claimed in claim 14, wherein:
the essentially cylindrical, hollow body is deformed by a rolling method.

16. The method as claimed in claim 14, wherein:
the support tube has an inner surface; and
the essentially cylindrical, hollow body is joined by mechanical deformation of at least one portion of the essentially cylindrical, hollow body to the inner surface of the support tube.

17. The method as claimed in claim 14, wherein:
at least one perforated tube is used as the essentially cylindrical, hollow body.

18. The method as claimed in claim 14, wherein:
a difference between an inner diameter of the support tube and an outer diameter of the essentially cylindrical, hollow body amounts to less than 1 mm.

19. A flow measuring device, having:
a measuring tube including a support tube, wherein said measuring tube is lined with an electrically and/or chemically insulating, isolating material; and
at least one, essentially cylindrical, hollow body is joined by mechanical deformation to said support tube, wherein:
said at least one essentially cylindrical, hollow body is embedded in said electrically and/or chemically insulating, isolating material.

20. The flow measuring device as claimed in claim 19, wherein:
said at least one essentially cylindrical, hollow body is composed of a sheet formed to a tube.

21. The flow measuring device as claimed in claim 19, wherein:
said at least one essentially cylindrical, hollow body has at least one perforating.

22. The flow measuring device as claimed in claim 21, wherein:
said at least one essentially cylindrical, hollow body joined to said support tube is free of perforating, at least in an end region serving for connecting said measuring tube to a pipeline.

23. The flow measuring device as claimed in claim 19, wherein:
said at least one essentially cylindrical, hollow body is joined to said support tube along at least one radially extending region.

24. The flow measuring device as claimed in claim 14, wherein:
said at least one essentially cylindrical, hollow body is composed of a first perforated tube with a first perforating and of a second perforated tube with a second perforating; and
said first perforated tube surrounds said second perforated tube.

25. The flow measuring device as claimed in claim 24, wherein:
said first perforating has holes with a first hole diameter and said second perforating has holes with a second hole diameter; and
said second hole diameter is smaller than said first hole diameter.

26. The flow measuring device as claimed in claim 14, wherein:
the difference between the inner diameter of said support tube and the outer diameter of said at least one essentially cylindrical, hollow body introduced into said support tube is greater than or equal to the elastic limit of the material, of which said at least one essentially cylindrical, hollow body is composed.
